(19) United States
(12) Patent Application Publication
(10) Pub. No.: US 2008/0002171 A1
(43) Pub. Date: Jan. 3, 2008

(54) METHOD FOR IN-LINE MONITORING A LENS CONTROLLER OF A PHOTOLITHOGRAPHY SYSTEM

(75) Inventors: Holger Schwekendiek, Freising (DE); Gernot Biese, Marzling (DE); Alexander Urban, Attenkirchen (DE)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/681,423

(22) Filed: Mar. 2, 2007

Related U.S. Application Data
(60) Provisional application No. 60/882,388, filed on Dec. 28, 2006.

(30) Foreign Application Priority Data
Mar. 2, 2006 (DE) 102006009703.3

(51) Int. Cl. G03B 27/42

(52) U.S. Cl. 355/61

(57) ABSTRACT

A method for in-line monitoring a lens controller of a photolithography system in which a plurality of wafers of a lot are processed in succession and which includes a lens for projecting a mask pattern on the wafers and a lens controller for correcting magnification of the lens includes the steps of printing a circuit pattern on each of the wafers of the lot by projecting a mask pattern on the wafers by means of a lens, determining a shot magnification value for a sample of the wafers, and continuously monitoring the variation of the shot magnification values, wherein a variation of the shot magnification values exceeding a first predetermined value indicates a failure of the lens controller.

### CROSS-REFERENCE TO RELATED APPLICATIONS

This application claims priority of German Patent Application Serial No. 10 2006 009 703.3, filed Mar. 2, 2006 and the benefit of U.S. Provisional Application Ser. No. 60/882,388, filed Dec. 28, 2006.

### TECHNICAL FIELD

The present invention relates to a method for in-line monitoring a lens controller of a photolithography system in which a plurality of wafers are processed in succession, wherein the photolithography system comprises a lens for projecting a mask pattern on the wafers and a lens controller for correcting lens heating effects and, in particular, magnification and focus of the lens.

In a photolithography system a mask pattern is imaged by means of a lens on a photosensitive layer which is present on the wafer. In order to form well-defined patterns it is important that the mask pattern is imaged in focus on the photosensitive layer and with an accurately determined magnification. During the exposure process the lens is heated by the exposure light and is thereby expanded. The magnification and the focal length of the lens are dependent on the temperature of the lens so that heating of the lens causes a variation in these parameters. A lens controller compensates for these effects, but the lens controller can fail or degrade over time.

Known methods for testing the lens controller are very time-consuming and thus are only performed in long time intervals. When a malfunction of the lens controller is detected, possibly a multitude of lots of wafers have already been exposed leading to a multitude of wrongly processed lots.

A known method for in-line monitoring the lens controller is to monitor variation in critical dimension data of integrated circuit features. However, it has been found that lens degradation/failure does not necessarily cause a variation of critical dimension data of integrated circuit features, so that these data are not solely appropriate to reliably detect a malfunction of the lens controller.

### SUMMARY OF THE INVENTION

The present invention provides a method for in-line monitoring a lens controller of a photolithography system by means of which a possible failure of the lens controller is immediately detected without significantly increasing processing costs.

According to an embodiment of the invention a circuit pattern is printed on each of the wafers of the lot by projecting a mask pattern on the wafers by means of a lens, a shot magnification value is determined for a sample of the wafers, the variation of the shot magnification values is continuously monitored, wherein a variation of the shot magnification values exceeding a first predetermined value indicates a failure of the lens controller. Since the variation of the shot magnification values is continuously monitored from wafer-to-wafer, a possible malfunction of the lens controller is immediately detected and a wrong processing of the subsequent wafers can immediately be prevented. In addition, the determination of the shot magnification is part of a typical exposure process so that determination of these values is not coupled with additional efforts that would increase the costs. The preferred method runs continuously and analyzes available lot data.

According to an embodiment of the invention the shot magnification value is determined in connection with overlay measurement, i.e. the measurement of how accurately a layer aligns with respect to another layer located above or below that layer. For that purpose the overlay deviation is measured between two overlying layers and, based on the overlay deviation, among other parameters, a shot magnification value is determined. A variation of the shot magnification values of the wafers of a lot exceeding a first predetermined value is an indicator for a malfunction of the lens controller. The shot magnification from wafer to wafer is a by-product of the overlay measurement so that monitoring of the lens controller according to the method of the present invention is based on available lot data and thus keeps the process costs low.

### BRIEF DESCRIPTION OF THE DRAWINGS

Further features and advantages read from the following description of a preferred method according to the present invention and with reference to the drawings in which:

FIGS. 1a, 1b, and 1c schematically show in-line monitoring the lens controller according to which a failure of the lens controller is determined by means of the standard deviation of the shot magnification values determined over one lot.

### DETAILED DESCRIPTION OF EMBODIMENTS

The structure and functioning of a photolithography system is known from prior art and shall not be discussed here in detail. A typical photolithography system comprises a reticle on which a circuit pattern is formed and a device known as a “stepper” for focusing the reticle pattern image on a wafer. The stepper contains a set of lenses (which is here referred to as “a lens”) to focus the reticle pattern image on a wafer. The light passing through the lens heats the lens, thereby expanding the lens and changing its focal length and magnification. A lens controller compensates for these effects so that the reticle pattern image is projected on the processed wafer in focus and with a predetermined magnification.

The reticle pattern image is focused on a light sensitive photoresist layer formed on the wafer. The photoresist is developed so that an image of the pattern is left on the wafer. The photoresist may then be used as a mask for the deposition or removal of material used to form the components and interconnections of a circuit on the wafer. If patterns for several chips have been formed on the reticle, they can be copied with a single shot (exposure). In the processing of semiconductor wafers typically a multitude of patterned layers are formed on top of each other so that the photolithography process is repeated many times with additional patterns and masks during fabrication of integrated circuits on the wafer.

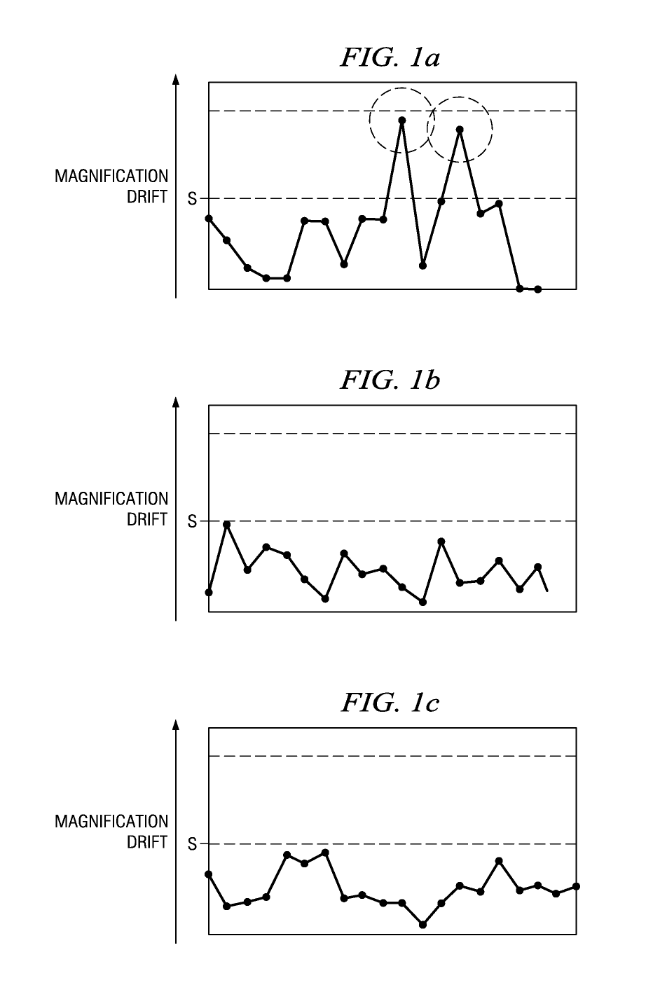

A failure or degradation of the lens controller will cause a wrong processing of a multitude of lots if it is not immediately detected. Thus, there is great interest in a method for reliably in-line monitoring the lens controller. FIGS. 1a to 1c illustrate a preferred method for in-line monitoring the lens controller of a photolithography system according to the present invention. The graphs shown in FIGS. 1a to 1c illustrate the magnification variation of the lens during processing in a first photolithography system (FIG. 1a), in a second photolithography system (FIG. 1b) and in a third photolithography system (FIG. 1c), respectively. The photolithography systems each comprise a different wafer stepper. Each point in the graphs corresponds to three times the a-value of the determined shot magnification values of one lot processed with the respective photolithography system. The term “a” stands for the standard deviation of the shot magnification values determined within one lot. Thus, each graph shows three times the standard deviation of the shot magnification values of all lots processed in the respective photolithography system. In case that the lens is heated during the exposure process and the lens controller does not compensate for this heating due to a malfunction, the shot magnification values are varying from exposure step (“shot”) to exposure step and from wafer to wafer. This variation is reflected in the value of the standard deviation. The greater the variation is, the higher the value of the standard variation is. If the standard deviation exceeds a predetermined value S, a malfunction or degradation of the lens controller is indicated. In the examples of FIGS. 1a to 1c only the photolithography system of FIG. 1a showed values of three times the standard deviation exceeding the predetermined value S. Thus, only in this photolithography system the shot magnification values vary to such a great extent that three times the a-value exceeds the predetermined value S which indicates a failure of the lens controller. Both in the second photolithography system and in the third photolithography system none of the 36-values exceeds the predetermined value S.

The shot magnification values can be determined in various manners. In one embodiment the shot magnification values are determined in connection with overlay measurement. Overlay measurement is the measurement of overlay accuracy between patterned layers, i.e. the measurement of how accurately a patterned layer aligns with respect to another patterned layer located above or below that layer. The overlay measurement is typically performed on the patterned photoresist layer prior to subsequent processes. For measuring the overlay deviation usually registration marks are used which are formed in each of the patterned layers. The shot magnification can be determined by means of the measured overlay deviation. Thus, in the preferred method there is no need for an additional measurement to determine the shot magnification, but it is determined in connection with a measurement which is a necessary process step in a photolithography process.

Typically, five registration marks on the wafer times four sites on the shot formed in each of the patterned layers are used for determining the overlay deviation. The shot magnification can be determined for all shots made on the wafer or only for selected shots made on the wafer. Likewise, the shot magnification can be determined for all wafers of one lot or only for selected wafers of one lot, e.g. for 4 wafers out of 25 wafers.

The statistical evaluation of the shot magnification values for determining the variation of the shot magnification over one lot, i.e. from wafer to wafer, can be made in different ways. In the embodiment shown in FIGS. 1a to 1c three times the standard deviation of the shot magnification values determined within one lot are calculated and are plotted as a dot in a graph. A high standard deviation exceeding the predetermined value S reflects a great variation of the shot magnification within one lot. Alternatively, it is also possible to directly determine the variation of the shot magnification within one lot, and, in case that the variation of the shot magnification values exceeds a predetermined value, a degradation of the lens controller is indicated. By way of example, the variation from the maximum shot magnification to the minimum shot magnification within one lot can be determined, or the variation between successive (or every second, third, etc.) values of the shot magnification can be determined for monitoring the lens controller.

The method according to the present invention runs continuously and is based on available lot data. Consequently, a possible malfunction of the lens controller is immediately detected without significantly increasing the production costs. Further, the period of time between time-consuming lens controller checks can be extended.

1. A method for in-line monitoring a lens controller of a photolithography system in which a plurality of wafers of a lot are processed in succession, said photolithography system comprising a lens for projecting a mask pattern on said wafers and a lens controller for correcting magnification of said lens, said method comprising the steps of
printing a circuit pattern on each of said wafers of said lot by projecting a mask pattern on said wafers by means of a lens,
determining a shot magnification value for a sample of said wafers,
continuously monitoring the variation of said shot magnification values, wherein a variation of said shot magnification values exceeding a first predetermined value indicates a failure of said lens controller.

2. The method of claim 1, wherein the standard deviation of the shot magnification values of said plurality of wafers of said one lot is determined, and wherein a value of the standard deviation exceeding a second predetermined value indicates a failure of said lens controller.

3. The method of claim 2, wherein an overlay deviation is determined between a first layer and a second layer of a wafer, said second layer overlying said first layer, and said shot magnification value is determined by means of said overlay deviation.

4. The method according to claim 3, wherein a first circuit pattern is printed on a first photosensitive layer of said wafer by projecting a first mask pattern on said layer, a second circuit pattern is printed on a second photosensitive layer of said wafer by projecting a second mask pattern on said second photosensitive layer, said second circuit pattern overlying said first circuit pattern, an overlay deviation is evaluated between said first and second mask patterns, and a shot magnification value is determined by means of said overlay deviation.

5. The method according to claim 3, wherein an overlay deviation between said first and second layer is evaluated using registration marks formed on said first and second layers.

6. The method according to claim 1, wherein determination of said shot magnification values is made for selected wafers of said lot.

7. The method according to claim 1, wherein an error is indicated in case that said variation of said shot magnification value exceeds said first predetermined value.
